(19) United States
(12) Patent Application Publication
(10) Pub. No.: US 2005/0243995 A1
(43) Pub. Date: Nov. 3, 2005

(54) Method and apparatus for canceling acoustic echo in a double-talk period

(75) Inventors: Sang-Ki Kang, Suwon-si (KR); Jung-Hoon Park, Suwon-si (KR); Gang-Youl Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/118,442

(22) Filed: May 2, 2005

(30) Foreign Application Priority Data
May 3, 2004 (KR) 10-2004-0030926

(51) Int. Cl. H04M 9/08

(52) U.S. Cl. 379/406.01; 379/406.06

(57) ABSTRACT

An apparatus and method for canceling an acoustic echo. In the apparatus, a double-talk detector detects whether a current period is a double-talk period or a single-talk period by determining whether a remote talker's signal and a local talker's signal are received simultaneously or at different times. A noise-robust affine projection (NRAP) adaptive filter estimates an acoustic echo included in the remote talker's signal using an NRAP algorithm if the detected current period is a double-talk period. A normalized least mean square (NLMS) adaptive filter estimates the acoustic echo included in the remote talker's signal using an NLMS algorithm if the detected current period is a single-talk period. The apparatus then generates an echo-canceled local talker's signal.

### CROSS-REFERENCE TO RELATED APPLICATIONS

This application claims the benefit under 35 U.S.C. §119(a) of Korean Patent Application No. 10-2004-0030926 entitled “Method And Apparatus For Canceling Acoustic Echo In A Double-Talk Period” filed in the Korean Intellectual Property Office on May 3, 2004, the entire disclosure of which is incorporated herein by reference.

### BACKGROUND OF THE INVENTION

1. Field of the Invention

The present invention relates generally to an acoustic echo cancellation method and apparatus. In particular, the present invention relates to a method and apparatus for minimizing speech quality degradation and an echo level in a double-talk period.

2. Description of the Related Art

When a call is being made using communication terminals, a signal of a remote talker can be directed into a microphone of a local talker's terminal via its speaker, and then fed back to a transmitter of the local talker's terminal. This phenomenon is generally called an “acoustic echo”. In particular, when a user talks over the communication terminal in a speaker mode such as in a conference room or when the user talks over the communication terminal in a hands-free mode in an automobile, the acoustic echo degrades the speech quality, thereby interfering with the speech communication. In addition, background noise, together with the acoustic echo, serves as a main cause of degraded speech quality. Therefore, between a speaker and a microphone of a communication terminal, an adaptive filter is used to estimate a route of an echo signal, an echo canceller is used to remove an influence of noise and echo signals from a base signal, and an adaptive algorithm is used to optimally estimate a varying acoustic route with minimized noise influences.

FIG. 1 is a diagram illustrating a detailed structure of a typical acoustic echo canceller. Referring to FIG. 1, an adaptive filter 110 continuously estimates an impulse response of an echo route using a remote talker's signal x(k), which is input as a reference signal, and an error signal e(k). Herein, ‘k’ denotes a time index, and its unit is determined according to the number of filtering taps. The term “echo route” refers to a route from a speaker 120 of a local talker's terminal to a microphone 130 of the local talker's terminal. Adaptive algorithms used for the estimation include Least Mean Square (LMS), Normalized LMS (NLMS), and Affine Projection (AP) algorithms. The AP algorithm is robust against noises, but requires a large amount of calculations. Therefore, the LMS or NLMS algorithms are most often used.

The adaptive filter 110 generates an estimated echo signal ŷ(k) using the estimated impulse response, and delivers the estimated echo signal ŷ(k) to a subtractor 140. The subtractor 140 then generates an echo-canceled error signal e(k) by subtracting the estimated echo signal ŷ(k) from a base signal d(k) including an echo. The echo-canceled error signal e(k) becomes an echo-canceled local talker's signal ŝ(k).

In a double-talk period for which a local talker and a remote talker are concurrently talking, an echo signal of a remote talker's signal and a local talker's signal coexist. In this case, in the LMS and NLMS adaptive algorithms used in the acoustic echo canceller, the adaptive filter fails to correctly estimate the echo signal due to an influence of the local talker's signal, such that coefficients of the filter are incorrectly updated. Therefore, the acoustic echo canceller uses a double-talk detector 100.

A double-talk detection (DTD) method can be classified as either a method using the power of a signal, or a method using a cross correlation. The signal power-based DTD method compares the power of a remote talker's signal with the power of a base signal, and determines the current period as a double-talk period if a power difference therebetween is larger than a predetermined value. If it is determined that the current period is a double-talk period, an adaptive filter performs filtering with previous coefficients without updating its filtering coefficients.

The conventional acoustic echo canceller described above performs filtering with the previous coefficients in a double-talk period without updating coefficients of an adaptive filter. Therefore, the acoustic echo canceller distorts a local talker's signal in the double-talk period, thereby degrading the speech quality.

To solve the foregoing problems, an attempt has been made to modify a mechanical structure of a communication terminal such that an output of its speaker increases, or the sensitivity of its microphone increases. In this case, however, the remote talker's signal increases in intensity, thereby increasing the echo. The increase in the echo deteriorates the speech quality and considerably affects the call quality.

Accordingly, a need exists for a system and method for effectively and efficiently canceling an acoustic echo at a communication terminal.

### SUMMARY OF THE INVENTION

It is, therefore, an object of the present invention to provide an apparatus and method for minimizing speech quality degradation and for canceling an echo by selecting a different adaptive algorithm according to whether a double-talk situation is detected.

It is another object of the present invention to provide an apparatus and method for minimizing speech quality degradation and for canceling an echo using a noise-robust algorithm upon detecting a double-talk period.

According to one aspect of the present invention, an apparatus is provided for canceling an acoustic echo. The apparatus comprises a double-talk detector for detecting whether a current period is a double-talk period or a single-talk period by determining whether a remote talker's signal and a local talker's signal are received simultaneously or at different times. The apparatus also comprises a noise-robust affine projection (NRAP) adaptive filter for estimating an acoustic echo included in the remote talker's signal using an NRAP algorithm if the detected current period is a double-talk period, and a normalized least mean square (NLMS) adaptive filter for estimating the acoustic echo included in the remote talker's signal using an NLMS algorithm if the detected current period is a single-talk period.

According to one aspect of the present invention, a method for canceling an acoustic echo is provided. The method comprises the steps of detecting whether a current period is a double-talk period or a single-talk period by determining whether a remote talker's signal and a local talker's signal are received simultaneously or at different times, estimating an acoustic echo included in the remote talker's signal using a noise-robust affine projection (NRAP) algorithm if the detected current period is a double-talk period, and estimating the acoustic echo included in the remote talker's signal using a normalized least mean square (NLMS) algorithm if the detected current period is a single-talk period.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a detailed structure of a conventional acoustic echo canceller;

FIG. 2 is a diagram illustrating a detailed structure of an acoustic echo canceller according to an embodiment of the present invention; and

FIG. 3 is a flowchart illustrating an operation of an acoustic echo canceller according to an embodiment of the present invention.

Throughout the drawings, like reference numerals will be understood to refer to like parts, components and structures.

### DETAILED DESCRIPTION OF THE EXEMPLARY EMBODIMENTS

A number of exemplary embodiments of the present invention will now be described in greater detail with reference to the annexed drawings. In the following description, a detailed description of known functions and configurations incorporated herein have been omitted for clarity and conciseness.

The embodiments of the present invention comprise an acoustic echo canceller that uses a different adaptive algorithm according to whether a double-talk situation is detected by a double-talk detector.

Specifically, the acoustic echo canceller uses a typical algorithm in a single-talk period and a noise-robust algorithm in a double-talk period, thereby minimizing noises and speech quality degradation in the double-talk period.

A description will now be made of a number of exemplary adaptive algorithms that can be applied in embodiments of the present invention.

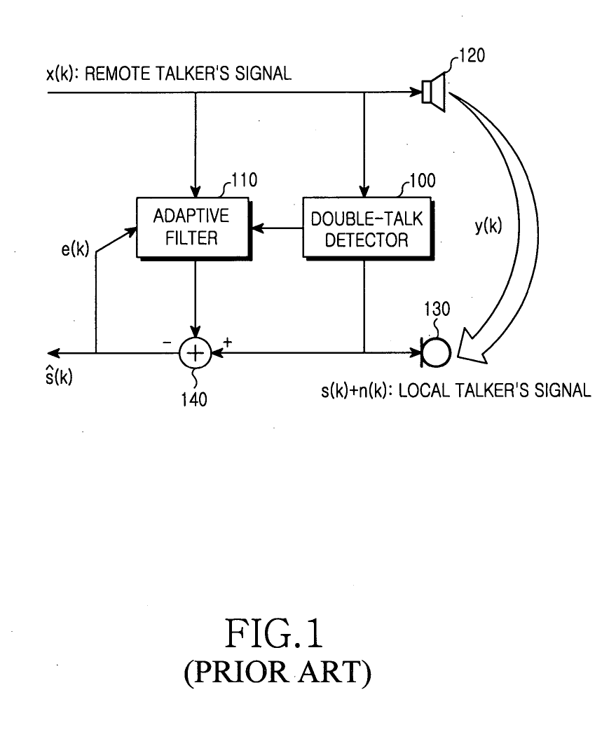

Referring again to FIG. 1, an adaptive filter 110 receives a remote talker's signal x(k), applies filtering coefficients calculated by an adaptive algorithm for canceling an acoustic echo to the remote talker's signal x(k), and subtracts an estimated echo signal ŷ(k) from a base signal d(k), thereby canceling the remote talker's signal x(k). Herein, the base signal d(k) is the sum of an echo signal y(k) that is directed into a microphone 130 of a local talker's terminal from a speaker 120 of the local talker's terminal, a voice signal s(k) of the local talker, and a background noise signal n(k). That is, the base signal d(k) can be expressed as noted below in Equation (1).
d(k)=y(k)+s(k)+n(k) (1)

An error signal e(k) is calculated by subtracting the estimated echo signal ŷ(k) from the base signal d(k) in accordance with Equation (2) below.

$$e ( k ) = d ( k ) - \hat{y} ( k ) \\ = s ( k ) + n ( k ) + y ( k ) - \hat{y} ( k ) \\ = s ( k ) + n ( k ) + r ( k ) \qquad ( 2 )$$

Herein, r(k) becomes smaller as the performance of an echo cancellation algorithm increases, and as the r(k) becomes smaller, an echo signal delivered to the remote talker becomes lower in intensity. The typical adaptive algorithm for minimizing the r(k) is a Least Mean Square (LMS) algorithm. An updated equation of the LMS algorithm can be written as noted below in Equation (3).
W(k+1)=W(k)+μ(k)e(k)X(k) (3)

Herein, W(k) denotes a vector representing coefficients of an adaptive filter. If the number of taps of the adaptive filter is given as L (for example, L=128 in a normal case), L coefficients w₁, w₂, . . . , w_{L} are used. In addition, μ(k) denotes an adaptive constant determined on an experimental basis, and e(k) denotes an error signal determined by subtracting the estimated echo signal ŷ(k) output from the adaptive filter 110, from the base signal d(k) input to the microphone 130 of the local talker's terminal. The value X(k) denotes a remote talker's signal, which can be comprised of as many samples as the number of taps (L) of the adaptive filter 110.

In the LMS algorithm represented by Equation (3), the remote talker's signal X(k) greatly affects the update of the coefficients. A Normalized LMS (NLMS) algorithm developed to solve this problem, normalizes an adaptive constant μ(k) into the power of a remote talker's signal as shown in Equation (4) below, thereby reducing an influence caused by a change in the remote talker's signal X(k).

$${μ}^{′} ( k ) = \frac{μ ( k )}{{X}^{T} ( k ) X ( k )} \qquad ( 4 )$$

Herein, T denotes a transpose of a vector.

However, the NLMS algorithm is not suited to color signals having a high auto-correlation. Herein, the term “color signal” refers to a signal generated in a particular frequency band, unlike the white signal generated over the full frequency band. Voice signals generated in a frequency band between 100 Hz and 1 KHz are typical color signals. Therefore, for the development of an adaptive filter suitable for voice signals, an Affine Projection (AP) algorithm has been developed.

The AP algorithm pre-whitens a remote talker's signal taking previous signals into consideration, thereby reducing a correlation of the remote talker's signal. In this manner, the AP algorithm solves the problem wherein an adaptation speed of filtering coefficients decreases for the color signals. Accordingly, in addition to the number of filtering taps, there is a whitening order parameter affecting the performance of an adaptive algorithm. Herein, the term “whitening order” refers to the number of previous signals which are taken into consideration for pre-whitening.

If, for example, a second-order AP algorithm is used given that an increase in the whitening order considerably increases the amount of calculations, a remote talker's signal X(k) undergoes pre-whitening as shown in Equation (5) below.

$$U ( k ) = X ( k ) - \frac{{X}^{T} ( k ) X ( k - 1 )}{{X}^{T} ( k - 1 ) X ( k - 1 )} X ( k - 1 ) \qquad ( 5 )$$

In Equation (5), U(k) denotes a signal that underwent pre-whitening by, taking one previous signal X(k−1) into consideration. The filtering coefficients of an adaptive filter are then adaptively updated by Equation (6) below.

$$W ( k + 1 ) = W ( k ) + \frac{μ ( k )}{{U}^{T} ( k ) U ( k )} e ( k ) U ( k ) \qquad ( 6 )$$

An error signal e(k) is expressed as e(k)=y(k)−X^{T}(k)·W(k). Herein, because the lengths of X(k) and W(k) are equal to the number of filtering taps (L), an increase in the number L excessively increases X^{T}(k)·W(k), thereby causing a divergence of the filtering coefficients. In order to remove an influence caused by the number of filtering taps, the power of an input signal and the number of filtering taps (L) are taken into consideration in a process of normalizing the adaptive filtering coefficients μ(k).

In the NLMS algorithm, for a double-talk period, the coefficients are incorrectly updated due to the local talker's signal. In the double-talk period, an increase in intensity of a remote talker's signal causes an increase in echo. Therefore, if the echo is canceled with the NLMS algorithm, the local talker's signal suffers severe distortion and an echo cancellation capability decreases.

However, the AP algorithm, because of its noise-robust feature, reduces the influence caused by the local talker's signal thereby providing an excellent characteristic even in the double-talk period. Therefore, a preferred embodiment of the present invention uses the noise-robust AP (NRAP) algorithm in a double-talk situation.

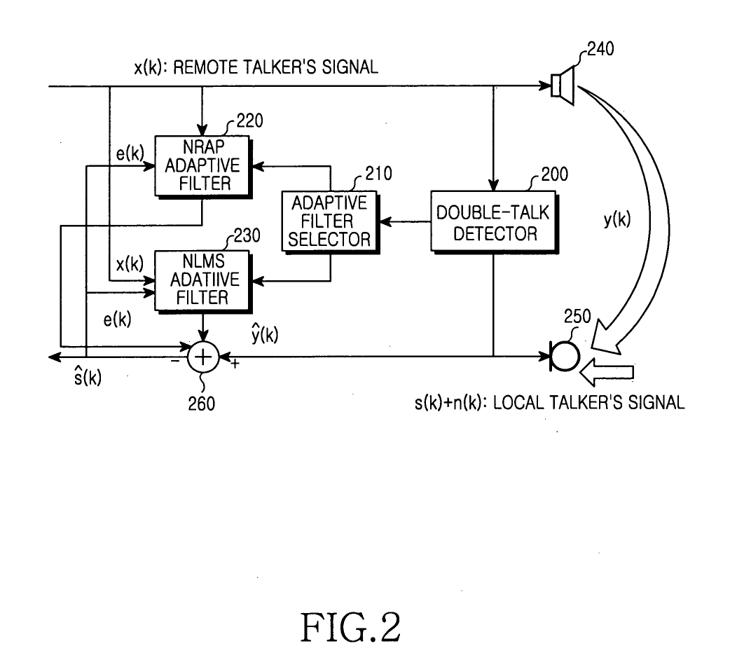

With reference to FIG. 2, a detailed description will now be made of an acoustic echo canceller according to an embodiment of the present invention.

FIG. 2 is a diagram illustrating a detailed structure of an acoustic echo canceller according to an embodiment of the present invention. Referring to FIG. 2, a double-talk detector 200 determines whether the current situation is a double-talk situation depending on whether a mixed signal (s(k)+n(k)) comprised of a local talker's signal s(k) and a background noise n(k) received from a microphone 250, and a remote talker's signal x(k), are received simultaneously or at different times.

An adaptive filter selector 210 selects an adaptive filter employing a different adaptive algorithm according to the current period detected by the double-talk detector 200. Specifically, the adaptive filter selector 210 selects an NLMS adaptive filter 230 employing an NLMS algorithm if the current period detected by the double-talk detector 200 is a single-talk period. However, if the current period detected by the double-talk detector 200 is a double-talk period, the adaptive filter selector 210 selects an NRAP adaptive filter 220 employing an NRAP algorithm.

If a double-talk period is detected by the double-talk detector 200, the NRAP adaptive filter 220 updates its filtering coefficients in accordance with Equation (6), and if a single-talk period is detected by the double-talk detector 200, the NLMS adaptive filter 230 updates its filtering coefficients in accordance with Equation (3).

Each of the NRAP and NLMS adaptive filters 220 and 230 continuously estimates an impulse response of an echo route using the input remote talker's signal x(k) and an error signal e(k), generates an estimated echo signal ŷ(k) using the estimated impulse response, and delivers the estimated echo signal ŷ(k) to a subtractor 260. The subtractor 260 generates an echo-canceled error signal e(k) by subtracting the estimated echo signal ŷ(k) from a base signal d(k) including an echo. The e(k) becomes an echo-canceled local talker's signal ŝ(k).

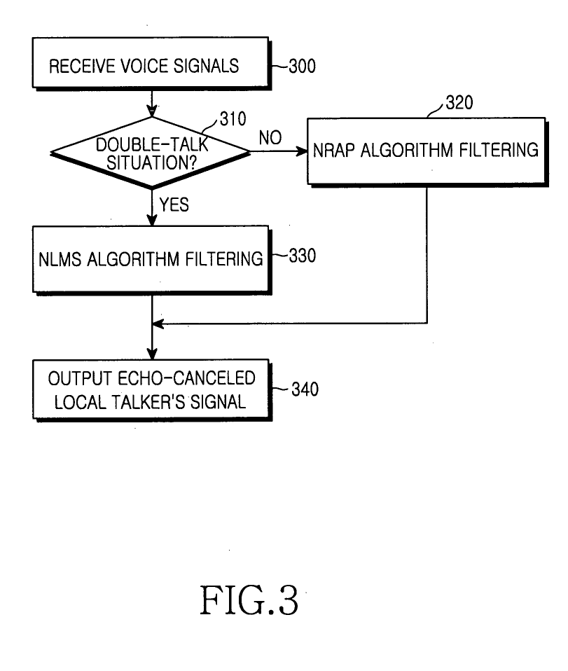

FIG. 3 is a flowchart illustrating an operation of an acoustic echo canceller according to an embodiment of the present invention. Referring to FIG. 3, in step 300, a double-talk detector 200 receives a remote talker's signal and a local talker's signal either simultaneously or at different times. In step 310, the double-talk detector 200 determines whether the current situation is a double-talk situation where the remote talker's signal and the local talker's signal are simultaneously received.

If it is determined that the current situation is a double-talk situation, then in step 320, an adaptive filter selector 210 selects an NRAP adaptive filter 220 and the NRAP adaptive filter 220 updates its filtering coefficients using Equation (6) and performs filtering with the updated filtering coefficients.

However, if it is determined that the current situation is not a double-talk situation, then in step 330, the adaptive filter selector 210 selects an NLMS adaptive filter 230 and the NLMS adaptive filter 230 updates its filtering coefficients using Equation (3) and performs filtering with the updated filtering coefficients.

In step 340, a subtractor 260 then subtracts an estimated echo signal ŷ(k) generated through the foregoing filtering from a base signal d(k) including an echo, thereby generating an echo-canceled error signal e(k), that is, an echo-canceled local talker's signal ŝ(k).

In this manner, the acoustic echo canceller updates filtering coefficients through a different algorithm according to the detection of the double-talk situation, and estimates an echo of a received voice signal.

As can be understood from the foregoing description, the acoustic echo canceller of the present invention updates the adaptive filtering coefficients even in a double-talk period to cancel an echo caused by a remote talker's signal without distortion of a local talker's signal, thereby securing the quality of the local talker's signal. Therefore, the embodiments of the present invention contribute to remarkable improvements in the call quality in a communication terminal supporting a hands-free function and a conference call function.

While the invention has been shown and described with reference to a number of certain exemplary embodiments thereof, it will be understood by those skilled in the art that various changes in form and details may be made therein without departing from the spirit and scope of the invention as defined by the appended claims.

1. An apparatus for canceling an acoustic echo, comprising:
a double-talk detector for detecting whether a current period is a double-talk period or a single-talk period by determining whether a remote talker's signal and a local talker's signal are received simultaneously or at different times;
a noise-robust affine projection (NRAP) adaptive filter for estimating an acoustic echo included in the remote talker's signal using an NRAP algorithm if the detected current period is a double-talk period; and
a normalized least mean square (NLMS) adaptive filter for estimating the acoustic echo included in the remote talker's signal using an NLMS algorithm if the detected current period is a single-talk period.

2. The apparatus of claim 1, wherein the NRAP algorithm is operable to update adaptive filtering coefficients using the following equation,
$$W ( k + 1 ) = W ( k ) + \frac{μ ( k )}{{U}^{T} ( k ) U ( k )} e ( k ) U ( k )$$
wherein U(k) denotes a signal that underwent pre-whitening taking one previous signal into consideration, W(k) denotes a filtering coefficient, L denotes a number of filtering taps, T denotes a transpose of a vector, μ(k) denotes an adaptive constant, e(k) denotes an error signal determined by subtracting an estimated echo signal ŷ(k) received from an adaptive filter from a base signal input to a microphone of a local talker's terminal, and X(k) denotes a remote talker's signal.

3. The apparatus of claim 1, wherein the NLMS algorithm is operable to update adaptive filtering coefficients using the following equation,
W(k+1)=W(k)+μ(k)e(k)X(k)
wherein W(k) denotes a vector representing coefficients of an adaptive filter, μ(k) denotes an adaptive constant, e(k) denotes an error signal determined by subtracting an estimated echo signal ŷ(k) received from the adaptive filter from a base signal input to a microphone of a local talker's terminal, and X(k) denotes a remote talker's signal.

4. A method for canceling an acoustic echo, comprising the steps of:
detecting whether a current period is a double-talk period or a single-talk period by determining whether a remote talker's signal and a local talker's signal are received simultaneously or at different times;
estimating an acoustic echo included in the remote talker's signal using a noise-robust affine projection (NRAP) algorithm if the detected current period is a double-talk period; and
estimating the acoustic echo included in the remote talker's signal using a normalized least mean square (NLMS) algorithm if the detected current period is a single-talk period.

5. The method of claim 4, further comprising the step of implementing the NRAP algorithm to update adaptive filtering coefficients using the following equation,
$$W ( k + 1 ) = W ( k ) + \frac{μ ( k )}{{U}^{T} ( k ) U ( k )} e ( k ) U ( k )$$
wherein U(k) denotes a signal that underwent pre-whitening taking one previous signal into consideration, W(k) denotes a filtering coefficient, L denotes a number of filtering taps, T denotes a transpose of a vector, μ(k) denotes an adaptive constant, e(k) denotes an error signal determined by subtracting an estimated echo signal ŷ(k) received from an adaptive filter from a base signal input to a microphone of a local talker's terminal, and X(k) denotes a remote talker's signal.

6. The method of claim 4, further comprising the step of implementing the NLMS algorithm to update adaptive filtering coefficients using the following equation,
W(k+1)=W(k)+μ(k)e(k)X(k)
wherein W(k) denotes a vector representing coefficients of an adaptive filter, μ(k) denotes an adaptive constant, e(k) denotes an error signal determined by subtracting an estimated echo signal ŷ(k) received from the adaptive filter from a base signal input to a microphone of a local talker's terminal, and X(k) denotes a remote talker's signal.

7. An apparatus for canceling an acoustic echo, comprising:
a double-talk detector for detecting a double-talk period and a single-talk period;
an adaptive filter selector for selecting an adaptive filter employing a different adaptive algorithm according to the period detected by the double-talk detector, wherein the adaptive filter selector is configured to select a normalized least mean square (NLMS) adaptive filter employing an NLMS algorithm if a single-talk period is detected and is configured to select a noise-robust affine projection (NRAP) adaptive filter employing an NRAP algorithm if a double-talk period is detected, and wherein each of the NRAP and NLMS adaptive filters continuously estimate an impulse response of an echo route and generate an estimated echo signal; and
a subtractor for generating an echo-canceled signal using the estimated echo signal.
